(19) United States
(12) Patent Application Publication
(10) Pub. No.: US 2023/0127854 A1
(43) Pub. Date: Apr. 27, 2023

(54) BICYCLE STEM

(71) Applicant: Mu-Rong Li, TAICHUNG CITY (TW)

(72) Inventor: Mu-Rong Li, TAICHUNG CITY (TW)

(21) Appl. No.: 17/511,497

(22) Filed: Oct. 26, 2021

(51) Int. Cl. B62K 21/12

(52) U.S. Cl. CPC B62K 21/12

(57) ABSTRACT

A bicycle stem includes a stem body and a lower assembly cover. The stem body includes a cabling groove facing downwardly, and a head tube hole and a handle groove disposed near two ends thereof, an end of the cabling groove is in communication with the handle groove and extended along a length direction of the stem body. The handle groove has a groove opening in communication with the cabling groove, and the stem body includes combination parts disposed near the groove opening. The lower assembly cover is combined with the combination parts to enclose the groove opening, so as to secure and support the handlebar assembled in the handle groove. Therefore, the operation of mounting or replacing the stein body between the handlebar having cables inside and the vertical head tube can be completed quickly, and the cables can be accommodated in the stem body.

### BACKGROUND OF THE INVENTION

### 1. Field of the Invention

The present invention relates to a technical field of bicycle device, and more particularly to a bicycle stem which can be completely installed and replaced quickly between a handlebar having cables and a vertical head tube.

### 2. Description of the Related Art

A stem is also called a head tube, and the literal meaning of the head tube also indicates the importance of the role of the stem. The stem bears the great responsibility of control with a handlebar, and is an important factor in determining the riding posture.

Generally speaking, using a stein with a shorter length has more flexibility in control because of the short radius of rotation; on the contrary, using a stem with a longer length provides less flexibility but allows a rider to ride with a forward gravity center, and it can increase the pedaling efficiency when sprinting in competition. Therefore, some riders will change the stem of different length according to different riding situations or for specific purposes.

In addition, in order to prevent various cables or lines (such as a brake line connected to a handlebar) from being wound, interfered, worn or sheared to cause damage when the bicycle stem is rotating, some companies develop a solution in which the cables can be stored inside the bicycle stem to achieve the effect of protecting the cables or lines.

For example, as shown in FIG. 13, which is a three-dimensional schematic view of a conventional stem with a cable accommodation space for cabling. In order to replace the conventional stem 70, the user must first disassemble a front cover 71 of the stem 70 to separate the handle 90, and then detach the stem 70 from the head tube 80, and then pull out brake lines 91 inserted inside the handle 90 from the handle 90. Next, as shown in FIG. 14, the stem cannot be replaced until the brake lines 91 are completely pulled out of the stem 70.

After the new stem is mounted, the user must insert the brake lines 91 into the new stem 70 and through the handle 90, to reconnect to brake handles. The above-mentioned operation is very complicated, troublesome and time-consuming; especially, when the bicycle owner has wrapped the handle tapes on the handles 90, the handle tapes must be disassembled and then re-wound during the replacement operation, and it makes the stem replacement operation more troublesome.

### SUMMARY OF THE INVENTION

An objective of the present invention is to provide a bicycle stem, and an operation of mounting or replacing a stem body of the bicycle stem between a vertical head tube and a handlebar in which a cable is inserted and assembled can be completed quickly, and the cable can be accommodated in the stem body, so as achieve the effect of protecting the cable assembled inside the handlebar.

In order to achieve the above-mentioned objective, the present invention discloses a bicycle stein including a stem body and a lower assembly cover.

The stem body includes a cabling groove having an opening facing downwardly, a head tube hole and a handle groove respectively disposed near two ends thereof, wherein an end of the cabling groove is in communication with the handle groove and extended along a length direction of the stem body, the handle groove includes a groove opening in communication with the cabling groove, and the stem body includes a plurality of combination parts disposed near the groove opening.

The lower assembly cover is configured to combine with the plurality of combination parts and enclose the groove opening, so as to secure and support a handlebar assembled in the handle groove.

### BRIEF DESCRIPTION OF THE DRAWINGS

The structure, operating principle and effects of the present invention will be described in detail by way of various embodiments which are illustrated in the accompanying drawings.

FIG. 1 is a perspective assembly view of a bicycle stem, according to the present invention.

FIG. 2 is a first perspective exploded view of a stem body mounted between a handle and a vertical head tube, according to the present invention.

FIG. 3 is a second perspective exploded view of the stem body mounted between the handle and the vertical head tube, according to the present invention.

FIG. 4 is a perspective assembly view of a stem body completely mounted between a handle and a vertical head tube, according to the present invention.

FIG. 5 is a schematic cross-sectional view taken along V-V of FIG. 4.

FIG. 6 is a perspective assembly view of a second embodiment of the present invention.

FIG. 7 is a first perspective exploded view of the second embodiment mounted between a handle and a vertical head tube, according to the present invention.

FIG. 8 is a second perspective exploded view of the second embodiment mounted between the handle and the vertical head tube, according to the present invention.

FIG. 9 is a perspective assembly view of the second embodiment completely mounted between the handle and the vertical head tube, according to the present invention.

FIG. 10 is a schematic cross-sectional view taken along X-X of FIG. 9.

FIG. 11 is a perspective assembly view of a third embodiment of the present invention.

FIG. 12 is a schematic cross-sectional view taken along XII-XII of FIG. 11.

FIG. 13 is a first perspective view of a conventional stem having a cabling accommodation space for cabling.

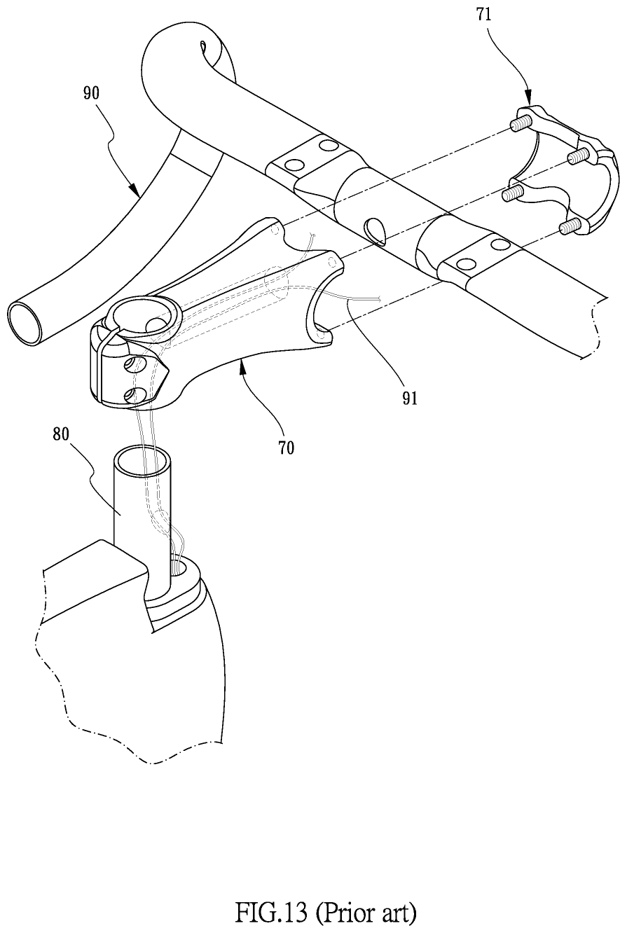

FIG. 14 is a second perspective view of the conventional stem having a cable accommodation space for cabling.

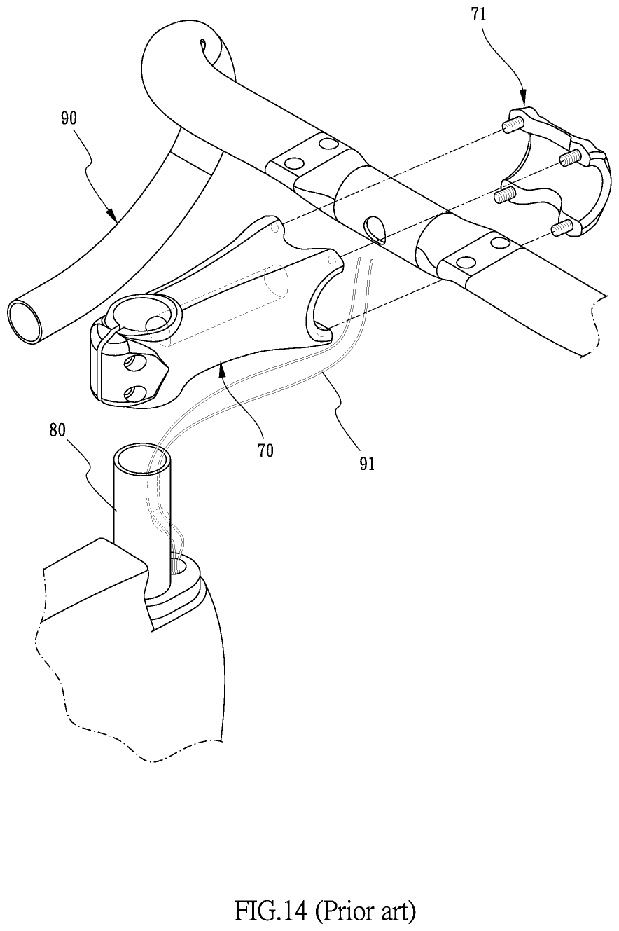

### DETAILED DESCRIPTION OF THE PREFERRED EMBODIMENTS

The following embodiments of the present invention are herein described in detail with reference to the accompanying drawings. These drawings show specific examples of the embodiments of the present invention. These embodiments are provided so that this disclosure will be thorough and complete, and will fully convey the scope of the invention to those skilled in the art. It is to be acknowledged that these embodiments are exemplary implementations and are not to be construed as limiting the scope of the present invention in any way. Further modifications to the disclosed embodiments, as well as other embodiments, are also included within the scope of the appended claims.

These embodiments are provided so that this disclosure is thorough and complete, and fully conveys the inventive concept to those skilled in the art. Regarding the drawings, the relative proportions and ratios of elements in the drawings may be exaggerated or diminished in size for the sake of clarity and convenience. Such arbitrary proportions are only illustrative and not limiting in any way. The same reference numbers are used in the drawings and description to refer to the same or like parts. As used herein, the singular forms “a”, “an” and “the” are intended to include the plural forms as well, unless the context clearly indicates otherwise.

It is to be acknowledged that, although the terms ‘first’, ‘second’, ‘third’, and so on, may be used herein to describe various elements, these elements should not be limited by these terms. These terms are used only for the purpose of distinguishing one component from another component. Thus, a first element discussed herein could be termed a second element without altering the description of the present disclosure. As used herein, the term “or” includes any and all combinations of one or more of the associated listed items.

It will be acknowledged that when an element or layer is referred to as being “on,” “connected to” or “coupled to” another element or layer, it can be directly on, connected or coupled to the other element or layer, or intervening elements or layers may be present. In contrast, when an element is referred to as being “directly on,” “directly connected to” or “directly coupled to” another element or layer, there are no intervening elements or layers present.

In addition, unless explicitly described to the contrary, the words “comprise” and “include”, and variations such as “comprises”, “comprising”, “includes”, or “including”, will be acknowledged to imply the inclusion of stated elements but not the exclusion of any other elements.

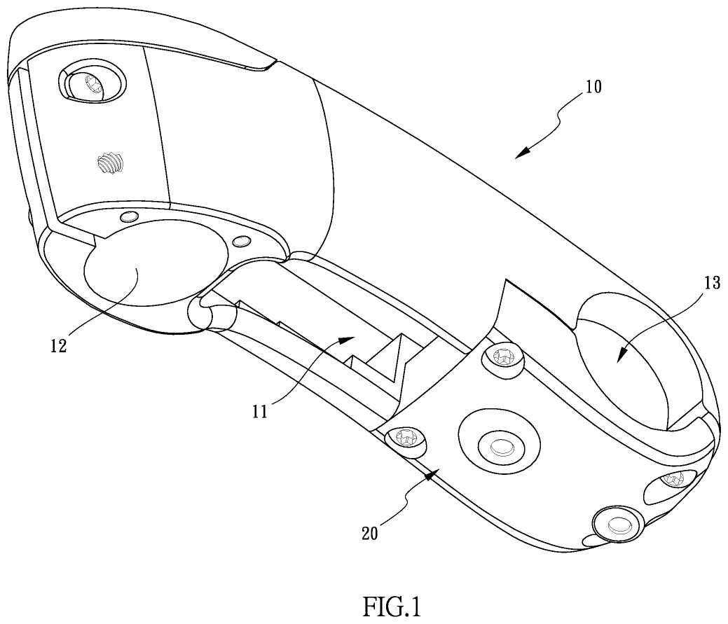

Please refer to FIGS. 1 to 12. A bicycle stem of the present invention can be implemented by three embodiments. As shown in FIGS. 1 to 5, the first embodiment of the bicycle stem includes a stem body 10 and a lower assembly cover 20.

The stem body 10 includes a cabling groove 11 having an opening facing downwardly, a head tube hole 12 and a handle groove 13 respectively disposed near two ends thereof. An end of the cabling groove 11 is in communication with the handle groove 13 and extended along a length direction of the stem body 10, the handle groove 13 includes a groove opening 131 in communication with the cabling groove 11, and the stem body 10 includes a plurality of combination parts 14 disposed near the groove opening 131.

The lower assembly cover 20 is configured to combine with the plurality of combination parts 14 and enclose the groove opening 131, so as to secure and support a handlebar 30 assembled in the handle groove 13.

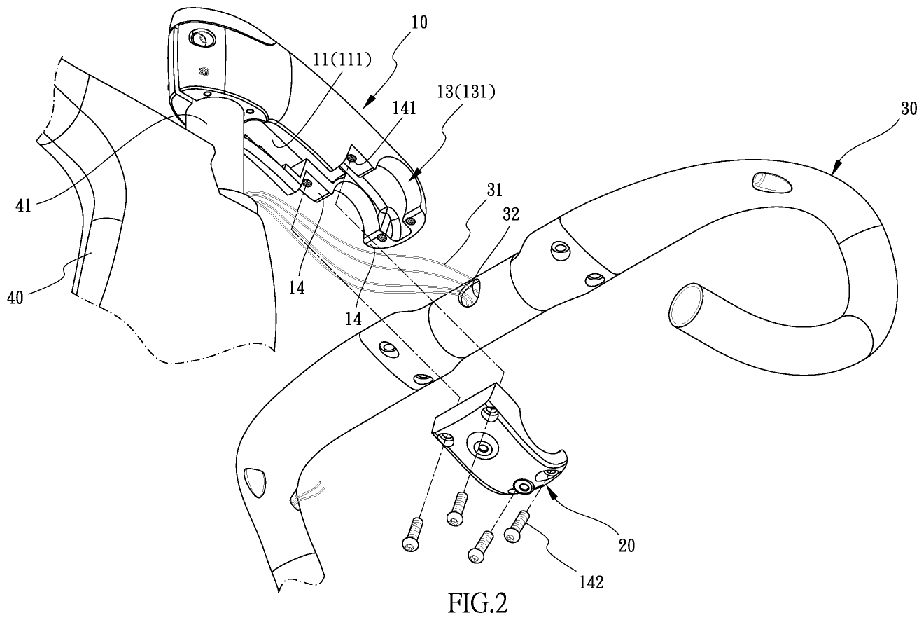

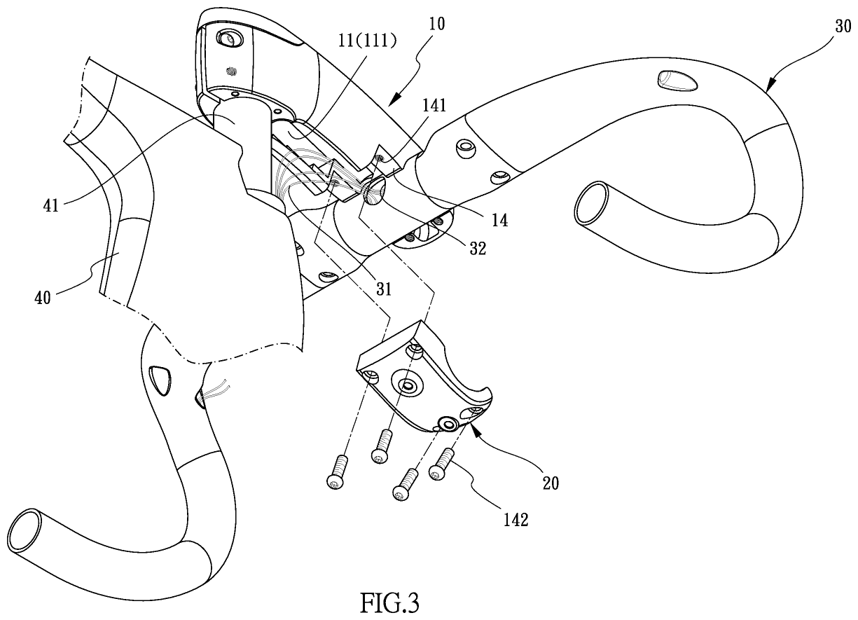

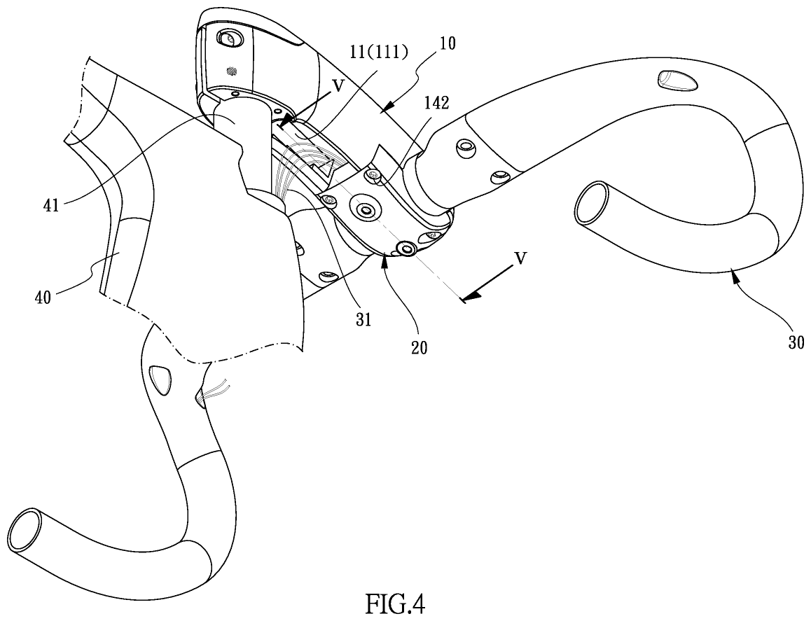

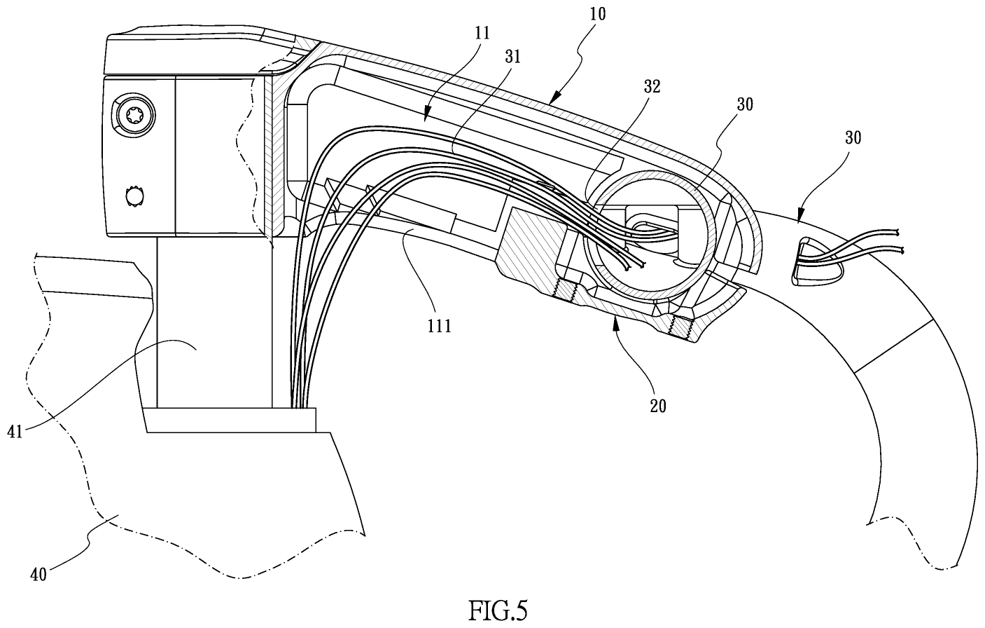

The implementation of the present invention is described in detail following the above description, the stem body 10 includes the cabling groove 11 having opening facing downwardly, and the head tube hole 12 and the handle groove 13 disposed near two ends thereof. The handle groove 13 includes the groove opening 131 in communication with the cabling groove 11, and the stem body 10 includes the plurality of combination parts 14 disposed near the groove opening 131. The axes of the head tube hole 12 and the handle groove 13 are different. Furthermore, as shown in FIGS. 2 to 5, the handle groove 13 has a horizontal axis and is configured to horizontally mount with the handlebar 30 in which the cable 31 is inserted and assembled. The head tube hole 12 has a vertical axis and is configured to mount with the vertical head tube 41 which is located in the bicycle frame 40 and the cable 31 is inserted therethrough. As shown in FIGS. 3 and 5, the handlebar 30 includes a cabling hole 32 for the cable 31 to expose out thereof and corresponding in position to the cabling groove 11, so that the cable 31 exposed out of the cabling hole 32 can be accommodated in the cabling groove 11. Next, the lower assembly cover 20 can be combined with the plurality of combination parts 14, to enclose the groove opening 131 and secure and support the handlebar 30, as shown in FIGS. 4 and 5. Therefore, the operation of mounting the stem body 10 with the vertical head tube 41 and the handlebar 30 having the cable 31 inside can be completed quickly.

In addition, as described above, in order to replace the stem body 10 of the bicycle stem of the present invention between the handlebar 30 and the vertical head tube 41, under a condition that the cable 31 is inserted and assembled in the cabling groove 11, the user just needs to first separate the lower assembly cover 20 from the stem body 10 and remove the cable 31 from the cabling groove 11, so that the user can replace the new stem body 10 and recombine the handle groove 13 with the handlebar 30 in which the cable 31 is inserted and assembled, to make the cable 31 exposed out of the cabling hole 32 accommodate in the cabling groove 11, so as to quickly complete the replacing operation, thereby achieving the effect of protecting the cable 31 assembled inside.

Compared with the prior art in which the brake line must be pulled out first before the new stem is replaced, the present invention indeed has non-obviousness in easy-to-use.

The features of the components of the present invention will be described in detail in the following paragraphs. As shown in FIGS. 1 to 5, the combination parts 14 respectively includes a plurality of combination holes 141 configured to combine with the lower assembly cover 20 by a plurality of screws 142, so as to secure the lower assembly cover 20 below the groove opening 13 of the cabling groove 11, to stably support the handlebar 30 assembled in the handle groove 13.

Preferably, each of the stem body 10 and lower assembly cover 20 can be an aluminum alloy structure.

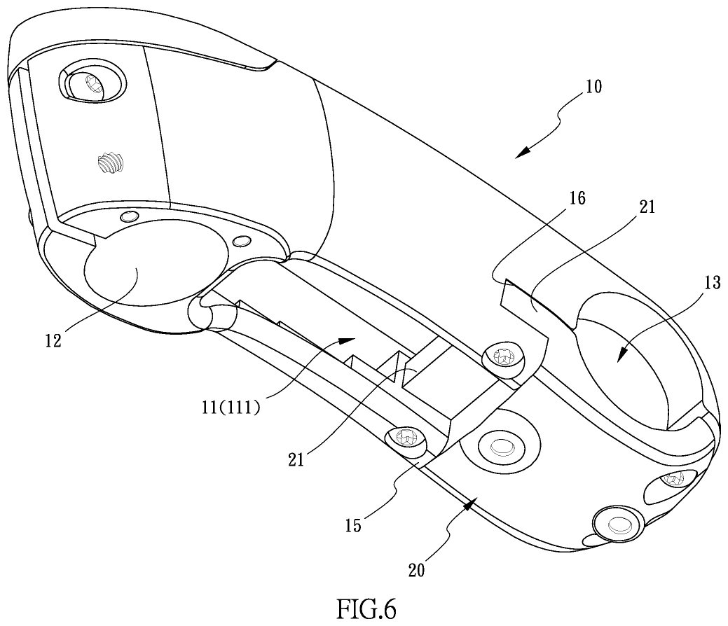

As shown in FIGS. 6 to 10, in the second embodiment of the present invention, the cabling groove 11 can have a lower groove opening 111 in communication with the groove opening 131, the stem body 10 can include two lower assembly parts 15 disposed on two sides of the lower groove opening 111, and the two lower assembly parts 15 are extended toward the handle groove 13, to make the stem body 10 have two slots 16 formed between the two lower assembly parts 15 and two of the plurality of combination parts 14. The lower assembly part 15 includes two second combination holes 151 corresponding in position to the two combination holes 141. The lower assembly cover 20 can include an insertion plate 21 protruded toward openings of the two slots 16, and two third combination holes 22 formed on the insertion plate 21. The insertion plate 21 is inserted into and assembled with the two slots 16, and the two third combination hole 22 are aligned to the two second combination holes 151, and the screws 142 can be locked into the third combination holes 22 through the second combination holes 151, so as to secure the lower assembly cover 20. Therefore, the insertion plate 21 can be inserted in and combined with the slots 16 between the two lower assembly parts 15 and the two combination parts 14, and the screws 142 in the two combination holes 141 are locked into the two second combination holes 151 to secure the lower assembly cover 20, so that the two lower assembly parts 15 can further provide structural reinforcement support for the lower assembly cover 20.

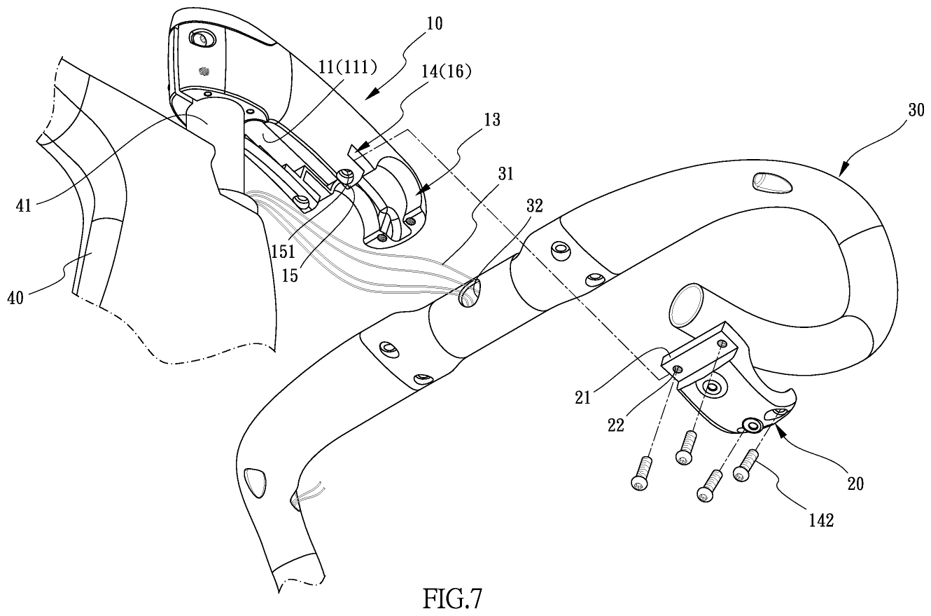

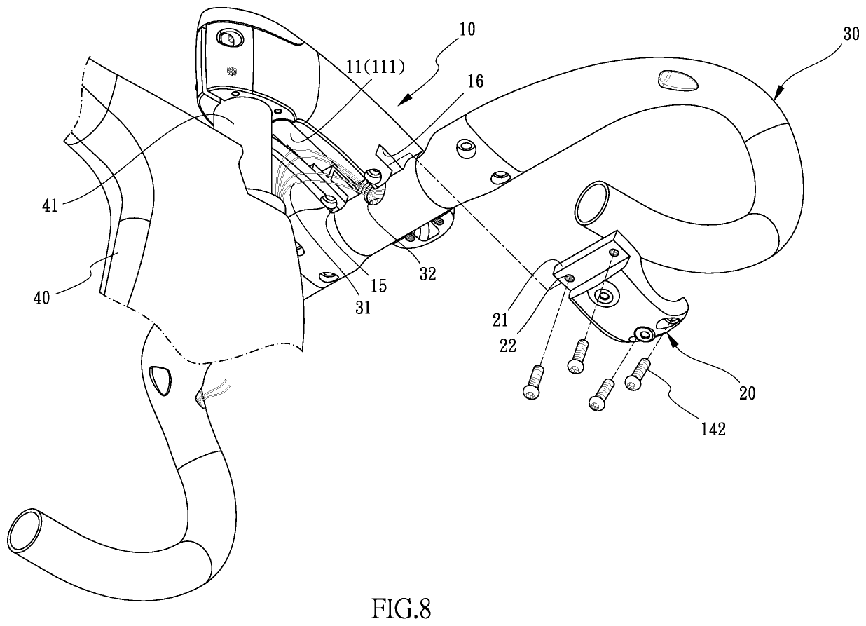

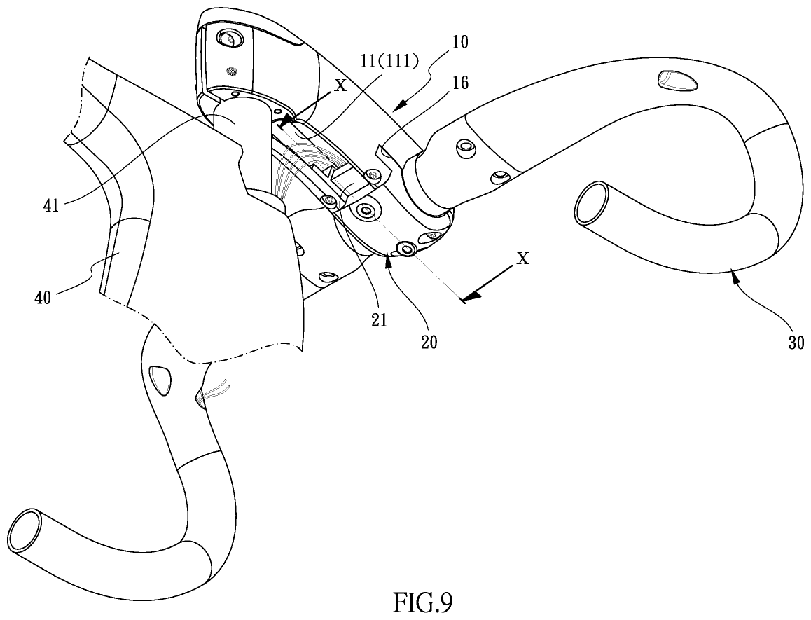

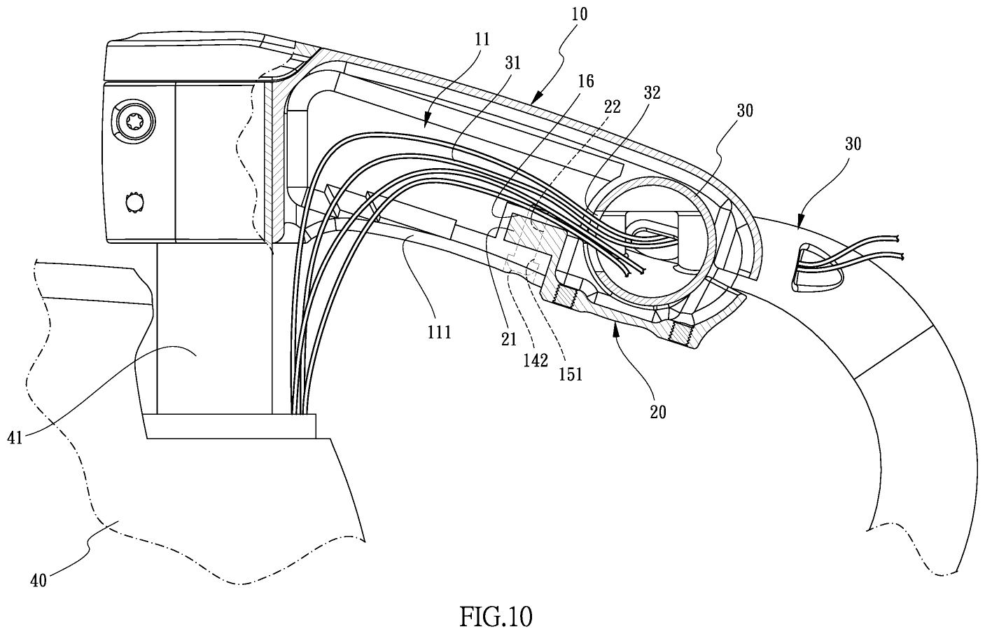

As shown in FIGS. 7 and 8, when the handle groove 13 with horizontal axial structure is horizontally mounted and combined with the handlebar 30 in which the cable 31 is inserted and assembled, the cabling hole 32 of the handlebar 30 for the cable 31 to expose out must correspond in position to the cabling groove 11, so that the cable 31 exposed out of the cabling hole 32 can be accommodated in the cabling groove 11; next, the lower assembly cover 20 is combined with the plurality of combination parts 14 to enclose the groove opening 131. As shown in FIGS. 9 and 10, according to the above-described contents, the operation of replacing the stem body 10 between the vertical head tube 41 and the handlebar 30 having the cable 31 can be completed quickly, and the cable 31 can be accommodated in the stem body 10, so as to achieve the effect of protecting the cable 31 assembled inside the handlebar 30.

Preferably, each of the stem body 10 and lower assembly cover 20 can be a carbon fiber structure.

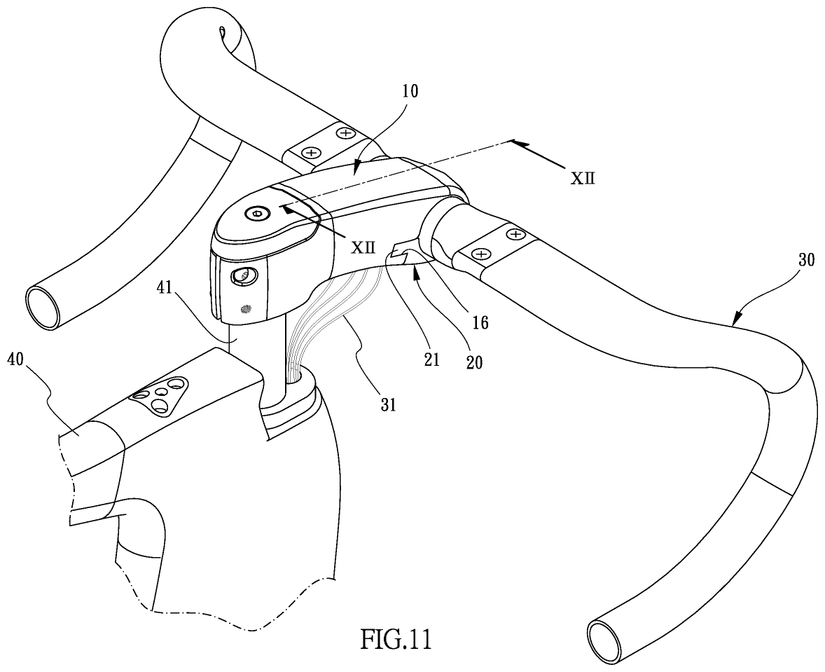

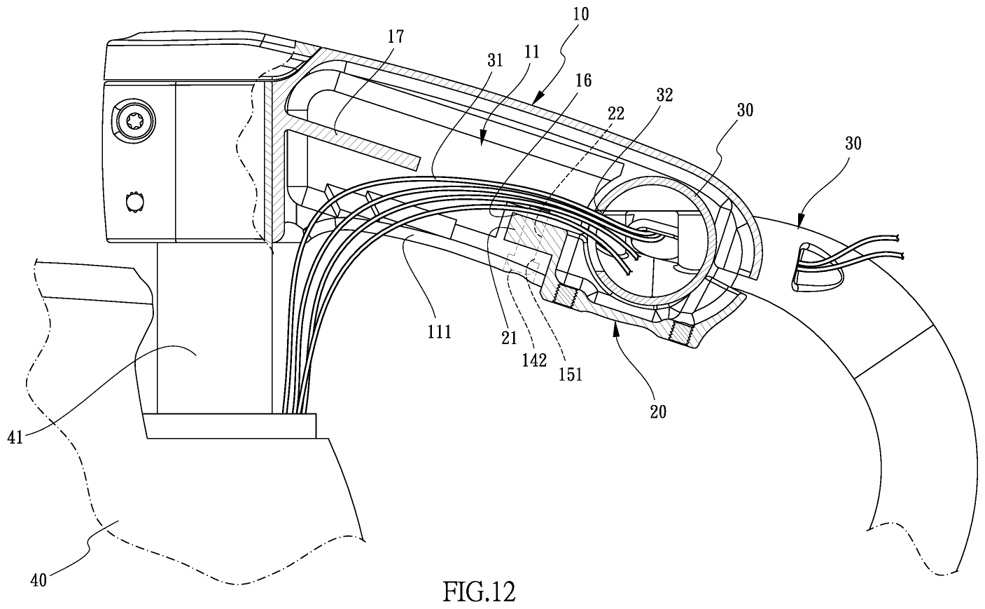

As shown in FIGS. 11 and 12, in the third embodiment of the present invention, the stem body 10 can include a reinforcing horizontal plate 17 disposed in the cabling groove 11 and between the groove bottom of the cabling groove 11 and the lower groove opening 111; the reinforcing horizontal plate 17 is disposed near the head tube hole 12. The reinforcing horizontal plate 17 can provide structural support for the hollow interior space of the cabling groove 11, to achieve the structural reinforcement effect.

The present invention disclosed herein has been described by means of specific embodiments. However, numerous modifications, variations and enhancements can be made thereto by those skilled in the art without departing from the spirit and scope of the disclosure set forth in the claims.

What is claimed is:

1. A bicycle stem, comprising:
a stem body comprising a cabling groove having an opening facing downwardly, a head tube hole and a handle groove respectively disposed near two ends thereof, wherein an end of the cabling groove is in communication with the handle groove and extended along a length direction of the stem body, the handle groove comprises a groove opening in communication with the cabling groove, and the stem body comprises a plurality of combination parts disposed near the groove opening; and
a lower assembly cover configured to combine with the plurality of combination parts and enclose the groove opening, so as to secure and support a handlebar assembled in the handle groove.

2. The bicycle stem according to claim 1, wherein the plurality of combination parts respectively comprise a plurality of combination holes configured to combine with the lower assembly cover by a plurality of screws.

3. The bicycle stem according to claim 2, wherein the cabling groove comprises a lower groove opening in communication with the groove opening, the stem body comprises two lower assembly parts disposed on two sides of the lower groove opening, and the two lower assembly parts are extended toward the handle groove to make the stem body have two slots formed between the two lower assembly parts and two of the plurality of combination parts, the two lower assembly parts comprises two second combination holes corresponding in position to the two combination holes, wherein the lower assembly cover comprises an insertion plate protruded toward openings of the two slots, and two third combination holes formed on the insertion plate, wherein the insertion plate is inserted into and assembled with the two slots, to make the two third combination holes align to the two second combination holes, and the plurality of screws are locked into the third combination holes through the second combination holes, so as to secure the lower assembly cover.

4. The bicycle stem according to claim 2, wherein each of the stem body and the lower assembly cover is an aluminum alloy structure.

5. The bicycle stem according to claim 3, wherein each of the stem body and the lower assembly cover is a carbon fiber structure.

6. The bicycle stem according to claim 4, wherein the stem body comprises a reinforcing horizontal plate disposed in the cabling groove and between a groove bottom and the lower groove opening of the cabling groove, and the reinforcing horizontal plate is disposed near the head tube hole.

7. The bicycle stem according to claim 5, wherein the stem body comprises a reinforcing horizontal plate disposed in the cabling groove and between a groove bottom and the lower groove opening of the cabling groove, and the reinforcing horizontal plate is disposed near the head tube hole.
